(19) United States
(12) Patent Application Publication
(10) Pub. No.: US 2007/0162524 A1
(43) Pub. Date: Jul. 12, 2007

(54) Network document management

(75) Inventors: Brian Coe, Scotts Valley, CA (US); Ayman A. Luqman, Belmont, CA (US)

Correspondence Address: GREENBERG TRAURIG, LLP, MET LIFE BUILDING, 200 PARK AVENUE, NEW YORK, NY, 10166, US

(73) Assignee: Yahoo! Inc.

(21) Appl. No.: 11/329,704

(22) Filed: Jan. 11, 2006

(51) Int. Cl. G06F 17/30

(52) U.S. Cl. 707/205

(57) ABSTRACT

Methods and systems for managing documents on a network, such as, for example the Internet. Links to websites and/or copies of the sites are saved in a personal account with a network content provider. In one embodiment, the saved information is retrieved from a user's computer. The saved websites can be sorted, searched and accessed by a network user through a network content provider website.

### FIELD OF THE INVENTION

This disclosure is directed to computers and computer applications and, more particularly, to a method and system of network document management.

### BACKGROUND OF THE INVENTION

When accessing the Internet and the World Wide Web, an Internet user typically executes, via a computer, a browser software program such as, for example, Netscape NAVIGATOR or Microsoft Internet EXPLORER™. The browser program, i.e., a browser, establishes a link to the Internet, via an Internet Service Provider (ISP), for example, and also provides an audio visual user interface for displaying Internet content and toolbars for interfacing with the browser.

Bookmarks are a common browser feature that allows an Internet user to quickly access web pages through a bookmarks window/menu/toolbar, or the like. When an Internet user selects a bookmark, the browser retrieves a Universal Resource Identifier (URI) associated with the bookmark and uses the URI to connect to the bookmarked webpage over the Internet. Bookmarks can be saved at local machines and/or stored at a server by an ISP. Browsers also allow the organization of bookmark into folders so Internet users can group common bookmarks together.

Although bookmarks are useful tools, they do not completely meet the needs of Internet users. For example, even with folders, a large number of bookmarks can be difficult to navigate through, and remembering the location of seldom used bookmarks can be hard to recall. In addition, bookmarks are typically associated with a URI of a webpage. Therefore, if the webpage changes, or is no longer available, then an Internet user cannot retrieve the information on that page when the bookmark was created. Accordingly, there is a desire for methods and apparatus for improved management of information available over a network of computers, such as, for example, the Internet.

### SUMMARY OF THE INVENTION

The invention as described and claimed herein satisfies this and other needs, which will be apparent from the teachings herein.

In an embodiment of the invention, a network content provider operates a network document management service. Users of the network, such, as, for example, Internet users, can store URIs, and copies of web pages on a network content provider computer, such as, for example, a server. When an Internet user browses the Internet and accesses a webpage that the user would like to revisit, instead of merely saving a bookmark to the webpage, the Internet user can save both a copy of the webpage and a link to the webpage at a network server.

The webpage and other network documents can be saved in a number of ways. For example, an Internet user can use a user selectable interface, such as, for example, a button in a links toolbar to access an interface they can use to save their website. Or in another embodiment, the Internet user can use a button on a downloadable toolbar to save their webpage, and access their saved documents.

In addition, a network content provider can track the search history of an Internet user. For example, the network content provider can receive search queries comprising terms that the Internet user is searching for, and return a list of search results related to the terms. The network content provider can maintain a list of the websites that the Internet user either visited or wished to store, and the network content provider can save the search term that generated the list and some or all of the visited sites.

An Internet user can manage their documents using a document management interface, provided, for example, by a network content provider webpage. Using the interface, an Internet user can search their documents for quick retrievals, and access saved copies of their documents. Since copies of documents are saved in addition to network identifiers, an Internet user does lose any information when a webpage is modified or shut down. Additionally, saving documents with a network content provider allows Internet users to access their information from any computer coupled to the Internet, and to share their saved documents, for example, through email, IM, RSS, etc. with other Internet users.

An exemplary network content provider server, can comprise a computer readable storage medium, having stored thereon instructions for at least one routine for providing a network document management service. The routine comprises receiving a request to save at least one element of at least one electronic document. The element or elements of the electronic document can be sent with the request or it can be sent separately. After receiving the electronic document, the routine continues by saving the electronic document on the network content provider computer. Elements of an electronic document can comprise, in embodiments of the invention, HTML, images, portable document files, URIs, etc.

Other objects and features of the invention will become apparent from the following detailed description, considering in conjunction with the accompanying drawing figures. It is understood however, that the drawings are designed solely for the purpose of illustration and not as a definition of the limits of the invention.

### BRIEF DESCRIPTION OF THE DRAWING FIGURES

The drawing figures are not to scale, are merely illustrative, and like reference numerals depict like elements throughout the several views.

FIG. 1 illustrates an exemplary system implemented according to an embodiment of the invention.

FIG. 2 illustrates a user side method for a network document management service implemented according to an embodiment of the invention.

FIG. 2A illustrates a user side method for retrieving documents implemented according to an embodiment of the invention.

FIG. 3 illustrates a network content provider side method for a network document management service implemented according to an embodiment of the invention.

FIG. 4 illustrates an exemplary user interface for a browser comprising user selectable components for saving documents to a network document management service implemented according to an embodiment of the invention.

FIG. 5 illustrates an exemplary pull down menu for a toolbar button implemented according to an embodiment of the invention.

FIG. 6 illustrates an exemplary user interface for saving documents to a network document management service implemented according to an embodiment of the invention.

FIG. 7 illustrates an exemplary list of search results implemented according to an embodiment of the invention.

FIG. 8 illustrates an exemplary save interface embedded in a list of search results implemented according to an embodiment of the invention.

FIG. 9 illustrates an exemplary interface for a network document management service implemented according to an embodiment of the invention.

FIG. 10 illustrates an exemplary search history implemented according to an embodiment of the invention.

FIG. 11 illustrates an exemplary shared folder implemented according to an embodiment of the invention.

### DETAILED DESCRIPTION OF EXEMPLARY EMBODIMENTS

There will now be shown and described in connection with the attached drawing figures several exemplary embodiments of a network document management system and methods for providing the same.

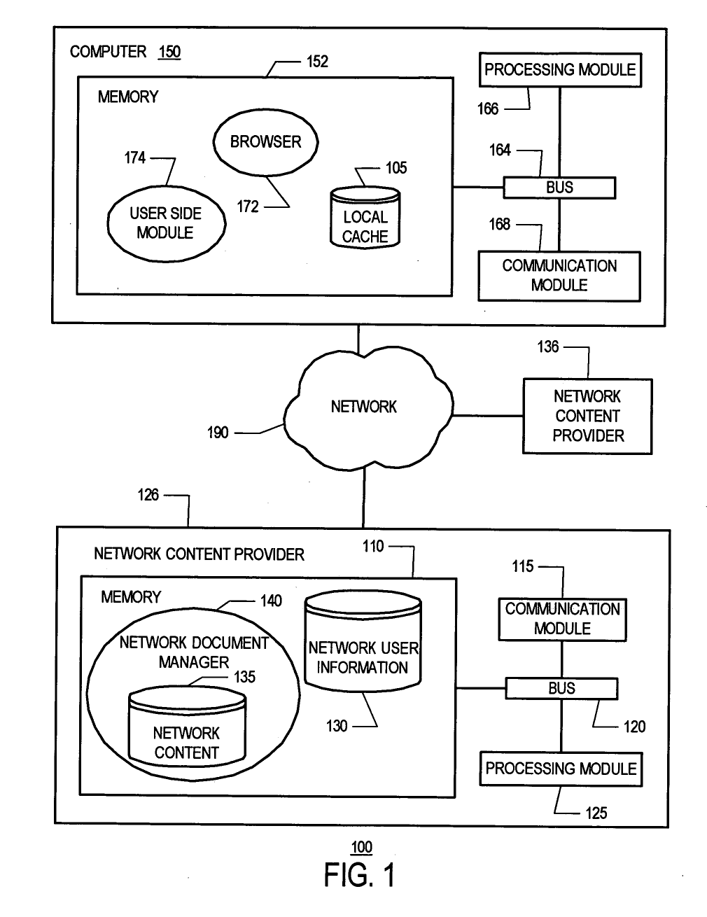

With reference to FIG. 1, there is shown an exemplary block diagram of a system 100 implemented in accordance with an embodiment of the invention. System 100 comprises a computer 150, a network content provider one 126, and a network content provider two 136, each coupled to a network 190, such as, for example, the Internet 190. A network user can use computer 150 to access content and/or services from providers 126 and 136 through the network 190.

Computer 150 comprises a processing module 166, a communication module 168 and memory 152 coupled together by bus 164. The modules of computer 150 can be implemented as any combination of hardware, software, hardware emulating software and reprogrammable hardware. The bus 164 is an exemplary bus illustrating the interoperability of the different modules of the computer 150. In different embodiments, there may be more than one bus and in other embodiments, some modules can be directly coupled instead of coupled to a bus 164. In alternate embodiments, computer 150 may be a desktop, a notebook computer, a Personal Digital Assistant (PDA), a handheld device, a wireless phone or any other device known or hereafter developed that is capable of performing functions as described herein.

The processing module 166 can be implemented as, in an exemplary embodiment, one or more Central Processing Units (CPUs), Field-Programmable Gate Arrays (FPGA), or any other component capable of executing computer applications. Communication module 168 comprises one or more I/O components used by the computer 150 to communicate with users and other devices. For example, components such as, a monitor, a keyboard, a mouse and a disk drive, can be used by a user to input and output information from the computer 150.

In addition, the communication module 168 facilitates two way communication between the computer and other electronic devices or systems, such as, for example, server computers provided by a network content provider one 126 and/or two 136. Components such as a modem, a network interface card (NIC), a wireless adapter, a Universal Serial Bus (BUS) adapter, etc., can be used by the computer 150 to communicate with the network 190, and/or with peripheral devices. The computer 150 may be communicatively connected to the network 190 through the communication module 168, for example, over one or more transmission media including but not limited to coaxial cable, copper wires and fiber optic cables. Communication between the computer 150 and the network 190 may also be accomplished via wirelessly.

Memory 152 can be implemented as volatile memory, non-volatile memory, rewriteable memory, etc., such as, for example, Random Access Memory (RAM), Read Only Memory (ROM) and/or flash memory. Memory 152 is illustrated as a single module in FIG. 1, but in some embodiments, memory 152 can comprise more than one memory module and some memory 152 can be part of other modules of computer 150, such as, for example, processing module 166.

In the embodiment illustrated in FIG. 1, memory 152 has stored thereon a browser 172, a user side module 174 and a local cache 105. A network user using computer 150 may gain access to the network 190, for example, the Internet 190, by using a browser 172. For example, a network user browsing the Internet 190 can use Universal Resource Identifiers (URIs), such as, for example, Universal Resource Locators (URLs), to locate and communicate with network content/service providers. In an embodiment of the invention, connection to the network 190 is provided through an Internet Service Provider (ISP).

Network content provider 136 and network content provider 126 can be implemented as computers, such as, for example, servers, connected to the network 190. Network content provider 136 has stored thereon, electronic documents that can be sent to computer 150 and viewed through the browser 172. Electronic documents can be saved in a local cache 105, for quick retrieval.

Electronic documents can comprise a plurality of elements, such as, for example, Hypertext Markup Language (HTML), electronic images, Portable Document Files (PDFs), flash files, etc. In addition, the identifier, such as, for example, the URL, associated with the electronic document can be consider as an element of the electronic document. On the Internet, an electronic document can be a webpage. Network content provider 136 can also have stored thereon, plug-ins, that can be downloaded onto the computer 150 and add functionality to the browser 172. Examples of plug-ins are downloadable toolbars, media players, etc.

In addition, to providing electronic documents, services, such as, for example, shopping, banking, music, email, and network document management, can also be provided over the network 190. Network content provider 126 can provide services, as well as content, to a network user through the browser 172. User side module 174 represents computer readable instructions that executes various routines to perform network services at the computer 150. User side module 174 can be a separate application, a plug-in to browser 172, or a part of a plug-in to a browser. When providing services over the network 190, computer processing can be performed at the user computer 150, the network content provider 126 computer, or at both devices. Therefore, in some embodiments of the invention, user side method 174 may not be necessary, and the network service can be performed using standard browser functionality. As will be described in further detail below, user side module 174, can be implemented as a button on a downloadable toolbar or a browser toolbar. A network user can save electronic documents using these buttons.

Network content provider 126 comprises communication module 115, processing module 125 and memory 110 coupled together by bus 120. Communication module 115, processing module 125, memory 110 and bus 120 can be implemented with components that are similar to the like named components of computer 150. The memory 110 of network content provider 126 has stored thereon, network document manager 140, network user information 130 and network content 135.

In accordance with an embodiment of the invention, network content provider 126 provides network document management for network users. In order to personalize service, network users maintain an account with the network content provider 126. Thus, network content provider 126 stores user information in database 130.

Network document manager 140 performs provider side routines for a network document management service, such as, for example, receiving requests from users to save network content, forwarding documents to other users, searching saved document, saving search histories, importing bookmarks and other functions that are described in further detail below. Network content saved by network users is stored in the network content database 135.

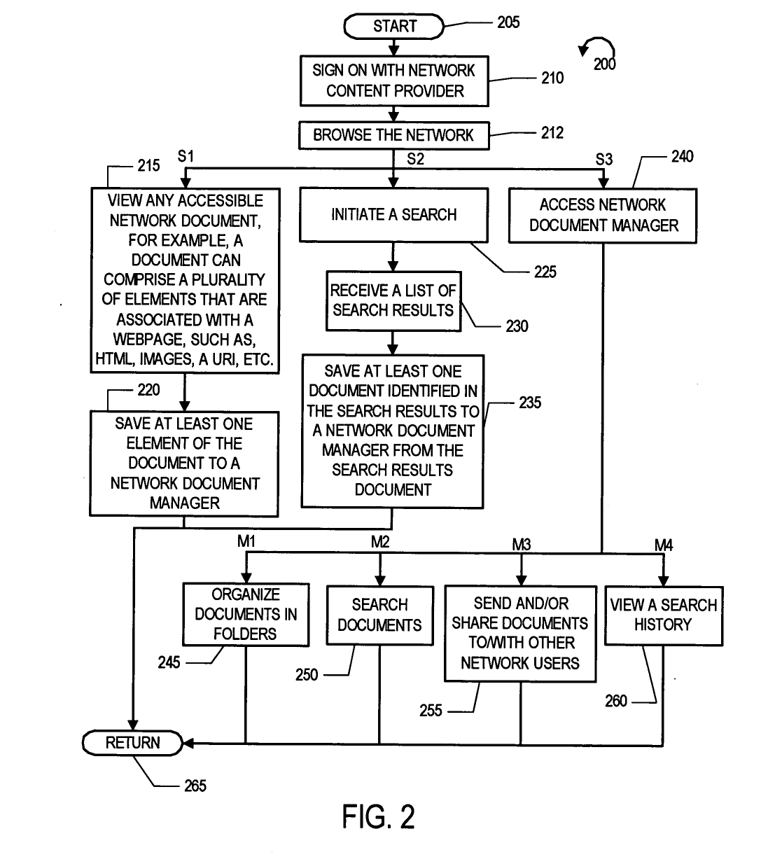

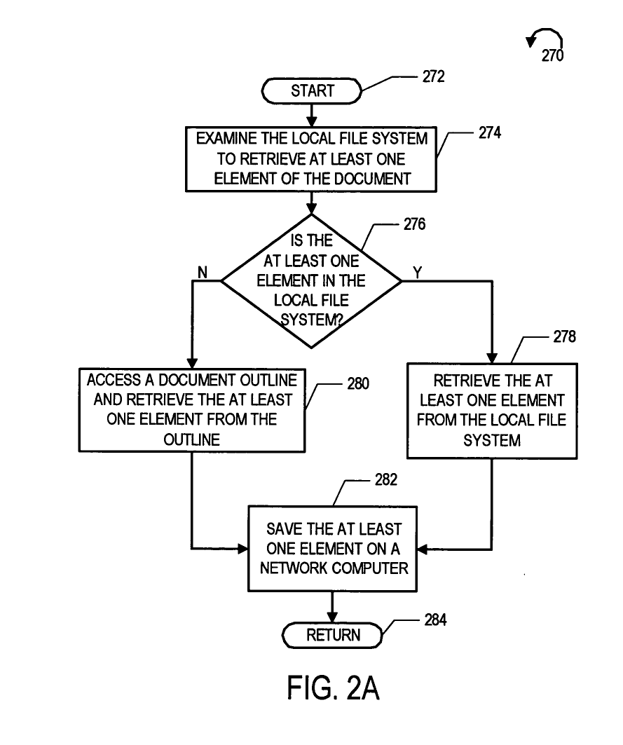

FIG. 2 illustrates an exemplary user side method 200 for a network document service, implemented in accordance with an embodiment of the invention. In an embodiment, user side module 174 of computer 150 in FIG. 1, can execute method 200. The user side method 200 starts in step 205, for example, with a network user turning on a computer and initiating a browser program. The network document service of the invention can be implemented over a plurality of different types of networks, including, for example, the Internet.

Following start step 205 processing of method 200 proceeds to step 210 where a user can sign on with a network content provider. For example, an Internet user can use a browser 172 to visit the website of a network content provider 126 and sign on with that network content provider 126. In alternate embodiments of the invention, the Internet user's browser, and/or a plug-in to the browser, such as, for example, a downloadable toolbar, can automatically sign on to the network content provider 126 when the browser is executed. After a network user has signed on with the network content provider 126, in step 210, processing of method 200 proceeds to step 212, where the network user browses the network.

A network user can perform a plurality of functions using the network. For example, following path S1, processing of method 200 proceeds from step 210 to step 215 where the network user views any accessible network document. Some network documents are only accessible by certain network users, for example, because they are in an Intranet, or have access to a password protected document. Any document that can be viewed by the browser can preferably be saved using embodiments of the invention. In an embodiment, an Internet user can use a browser, and other applications, to access web pages and other media over the Internet. As mentioned above, a webpage can comprise a plurality of elements that are associated with the webpage, such as, for example, hypertext markup language (HTML), images, a URL, etc.

As an Internet user accesses the Internet, they may frequently visit certain websites or they may comes across websites that they might want to view at some time in the future. A network document management service, implemented in accordance with an embodiment of the invention, allows an Internet user to save, share and organize information on the Web. Thus, processing of method 200 proceeds from step 215 to step 220, where a network user saves at least one element of an accessed document to a personal network manager provided by network content provider 126.

In an embodiment of the invention, just the network identifier, and optionally the title, of the document is sent to the network content provider 126. In alternate embodiments, a copy of the whole document is accessed from the network or the network user's local cache 105 and saved at a network content provider 126. If the elements of the document are not found in the cache, they can be accessed from the Document Object Model (DOM) for the document. Websites on the Internet are constantly updating, so the document that a URL is associated with can change over time. Therefore, saving copies of documents as opposed to only their network identifier, such as, for example, a URL, allows a network user to find the information that they originally accessed. In addition, saving information with a network content provider 126 allows a network user to access their saved information from any computer with a browser and a connection to the network.

In one embodiment of the invention, when a user wishes to save an electronic document or a part of an electronic document to their personal network manager, the user selects a button in a browser toolbar. The button opens a form in a separate window, the form comprises a save button, the URL of the electronic document and a field that allows the user to give the electronic document a title. When the user selects the save button, the form is sent to a content provider server, which saves the requested information. In one embodiment, the server uses the provided URL to retrieve the requested information directly from the source. In one embodiment, the content provider may store cached versions of Internet webpages, for example, for search purposes. In this embodiment, the server can retrieve the requested information from a content provider's cache.

In general, a content provider server does not have direct access to a user computer's cache, and does not have access to a browser's DOM when the content is from another site. Thus, metadata, such as, for example, content type, content size and language are not generally available to the server. In addition, the content of non-HTML documents, such as, for example, Word files, excel files, PowerPoint files, PDFs, SWFs and other files, once loaded into a browser, may not be available to the server to save to the user's account via the browser DOM. Furthermore, the server is also generally denied access to content behind a login account and content on an Intranet. In addition, content dynamically generated or modified by script or add-ons after the initial document is loaded in the browser in not generally available to a server.

In one embodiment, a browser extension, such as, for example, a downloadable network toolbar, can be used to gain access to the browser's cache and to access the browser's DOM. By using the local browser's cache, the browser extension can save both HTML and non-HTML documents with the user's account, and by accessing the DOM, the browser extension can provide metadata to the content provider. In addition, by retrieving the requested information from the local computer, the content provider does not have to make another independent request directly to the remote server hosting the viewed document. Also, content behind a login account, content on an Intranet and dynamically created or modified content can all be saved to a user's account since the documents are retrieved from the local computer.

In one embodiment, a button on a downloadable network toolbar can be used by a user to save electronic documents, or parts of an electronic document to their account. FIG. 2A illustrates one embodiment of method 270, which can be executed by a toolbar, for retrieving and saving electronic documents. Saving step 220 of FIG. 2 can be implemented, in one embodiment, using method 270.

Method 270 starts in step 272. Then, in step 374, the toolbar examines the local file system to retrieve the requested information. In step 276, if the requested information is located in the local file system, method 270 proceeds to step 278, where the requested information is retrieved from the local file system. In one embodiment of the invention, a local copy of the document is retrieved from the browser's cache. Following step 278, method 270 proceeds to step 282.

Returning to step 276, if the requested information is not in the local file system, method 270 proceeds from step 276 to step 280 where the toolbar accesses a document outline, such as, for example a DOM, to retrieve the requested information. For example, in one embodiment, the toolbar attempts to return all the data between the <HTML> tags in an electronic document by accessing the DOM. This can be done by getting the raw HTML (innerHTML property), or walking the DOM to construct a file from the dynamic HTML. Following step 280, method 270 proceeds to step 282, where the retrieved information is saved on a network computer, such as, for example, a content provider server. In one embodiment, the retrieved information is sent to the network computer via HTTP “Post.” Following step 282, method 2700 proceeds to return step 284. In one embodiment, processing returns to step 265 of method 200.

In addition to saving a copy of the document, in alternate embodiments of the invention, a network user can also have the option of sending a copy of the document to other network users for example, through email and/or through instant messaging. Following step 220, processing of method 200 proceeds to return step 265 where the method 200 returns to step 212 where a network user browses the network.

From step 212, a network user can also follow path S2 and proceed from step 212 to step 225 where the network user initiates a search. A search can be initiated from a search page provided by a network content provider 126 and/or can be initiated from a downloadable toolbar installed on a browser 172. After initiating the search in step 225, the network user receives a list of search results from the network content provider in step 230. The search results can be, in an embodiment, a list of hyperlinks to network documents related to a search term.

As a network user reads the search results, in step 235, the network user can save at least one element of documents, or the entire document, identified in the search results to a network document manager directly from the search results document. Following step 235, processing proceeds to return step 265 where the network user can return to step 230 and view other search results, or they can return to step 212 and browse the network.

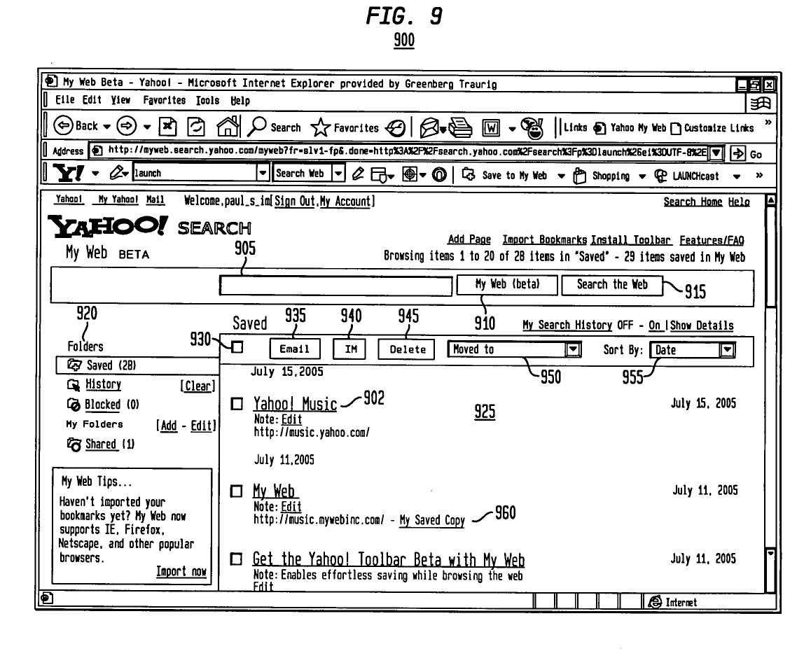

Returning to step 212, an network user can also follow path S3, thus, processing proceeds from step 212 to step 240 where the network user accesses their personal network manager. A network document manger can be an interface that is provided through a webpage and operated by a network content provider 126. A network user accesses this interface to mange their saved documents. An exemplary network manager is illustrated in FIG. 9, and will be described below.

Using a network document manager, a network user can perform a plurality of tasks, for example, following path M1, in step 245, a network user can use the network document manager to organize documents in folders. An exemplary network document manager comprises standard folders and personalized folders, which can be edited. Documents can be placed in folders to group similar documents. When the network user is finished organizing their documents, processing proceeds from step 245 to step to return step 265. The network user can then return to step 212 and browse the network, or return to step 240 and continue to manage their documents.

Returning to step 240, a network user can follow path M2, in step 250, and search their saved documents. After browsing the network for a long time, a network user can have a large number of documents and/or folders. Thus, the network document manager allows a network user to search their documents. Searching allows a network user to quickly locate a document amongst a plurality of documents. Following step 250, when the network user is finished searching their documents, processing proceeds from step 250 to step to return step 265. The network user can then return to step 212 and browse the network, or return to step 240 and continue to manage their documents.

From step 240, a network user can also follow path M3 to step 255 and send and/or share documents to/with other network users. For example, a network user can send a document to another network user using email and/or instant messaging. In addition, a network user can save documents in a shared folder that can be accessed by other network users, for example, through RSS. Still in other embodiments, a network user can publish their documents on a personalized Internet page. Following step 255, when the network user is finished sharing their documents, processing proceeds from step 255 to step to return step 265. The network user can then return to step 212 and browse the network, or return to step 240 and continue to manage their documents.

A network content provider 126 can save the search history of a signed on network user. For example, the network content provider 126 can save search terms used by the network user, and save the sites accessed by the user from the results of the search term. Therefore, returning to step 240, a network user, following path M4, can view their search history in step 260. From this search history list, the user can revisit the sites, and/or save them to their network document manager. When the network user is finished with their search history, processing proceeds from step 260 to step to return step 265. The network user can then return to step 212 and browse the network, or return to step 240 and continue to manage their documents. When a network user is finished browsing the network, they can sign off with the network content provider, and/or shut down their browser 172.

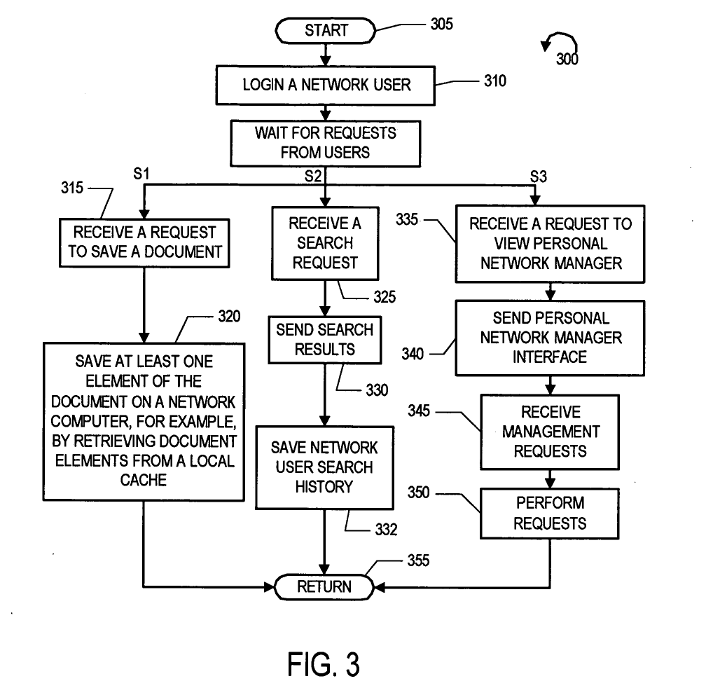

FIG. 3 illustrates an exemplary network document management method 300, implemented from the network content provider side. In an exemplary embodiment of the invention, network document manager 140 of network content provider 126 illustrated in FIG. 1, can execute method 300. Network document manager method 300 begins in step 305, for example, with the network content provider 126 initiating a network document management service for network users.

Following start step 305, in step 310 the network content provider 126 logs in a network user. Once a network user is logged in with the network content provider 126, processing proceeds to step 312, where the network content provider 126 waits for requests from the network user.

For example, following path S1 to step 315, the network content provider 126 receives a request to save a document. In some embodiments of the invention, the request to save a document may comprise the elements of the document that a network user wishes to save. In other embodiments, the request can come first and then the document can be received at a later time. Following step 315, in step 320, the network content provider 126 saves at least one element of the requested document on a network computer. For example, the network user can have the option of saving just an identifier associated with a document or a copy of the entire document. In an embodiment of the invention, network document elements are preferably retrieved from a user's local cache, and/or optionally from a DOM, or from the network. Following step 320, processing proceeds to step 355, where the method returns to step 312, in which the network content provider 126 waits for additional requests from network users.

Returning to step 312, processing can also follow path S2 to step 325 where the network content provider 126 receives a search request. The search request can comprise a search term or terms that a network user is interested in. In response to receiving a search request processing proceeds to step 330 where the network content provider 126 executes the search and sends its results back to a user.

Following step 330, processing proceeds to step 332 wherein the network content provider 126 saves the search history of the network user. A search history can comprise the search term or terms used to by the user and the documents viewed by the user from the search result list. Using this search history, the network content provider 126 can provide a list of visited web sites to a network user at a later time. Processing then proceeds from step 332 to return step 335. Method 300 can return to step 312 where the network content provider 126 waits for another request from a user.

Returning to step 312, once a network user has logged in with a network content provider 126, the user can request to mange their saved documents. Thus, processing can proceed to step 335 of path S3. In step 335, the network content provider 126 receives a request to view a network document manager. In response to the request, the network content provider 126, in step 340, sends a network document manager interface to the network user. The interface can, for example, default to show recently saved documents.

Following step 340, in step 345, the network content provider 126 receives management requests from the network user. As mentioned in the description of FIG. 2, network management can comprise the organization of document folders, searching documents, sending or sharing documents with other network users, viewing a search history and other requests. In step 350, the network content provider 126 performs the requested operations. Following step 350, processing proceeds to return step 355. Method 300 can return to step 312, where the network content provider 126 awaits another request from a network user. Provider side method 300 ends when a network user logs off the network content provider system.

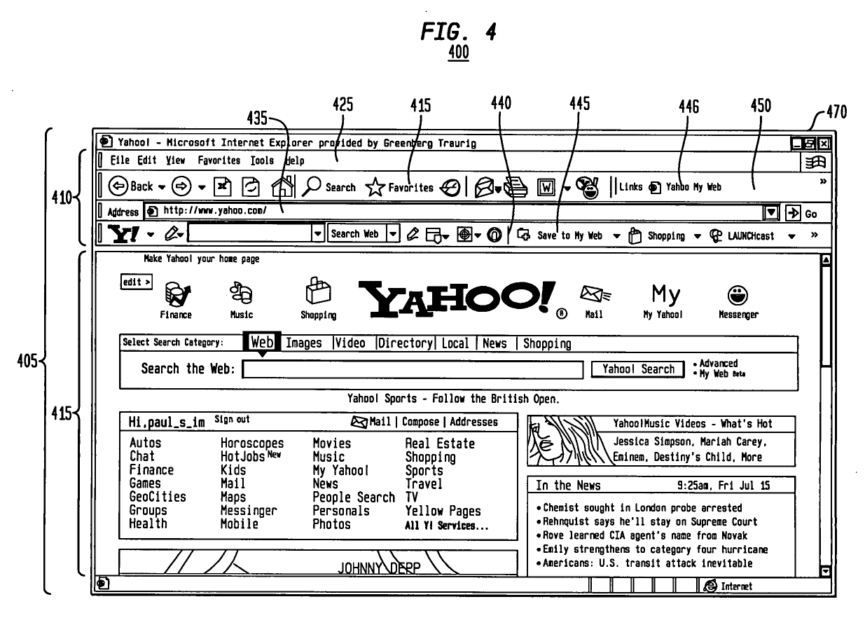

FIG. 4 illustrates an exemplary browser application interface implemented in accordance with an embodiment of the invention. Browser interface 400 comprises an application window 405, a toolbar/menu section 410 and a display section 415. Browser application window 405 comprises control buttons 474 for minimizing, maximizing and closing the browser window 405.

Toolbar/menu display section 410 comprises one or more toolbars, menu bars and the like, used to aid a network user in browsing a network, such as, for example, the Internet. Browser 400 comprises a menu bar 425, a standard toolbar 415, a links toolbar 450 an address bar 435 and a downloadable toolbar 440.

Browser display section 415 comprises a display area for displaying documents, such as, for example, webpages, to a network user. The display section 415 of browser 400 illustrates the home page of an network content provider. This home page provides a portal to many Internet sites and services, such as, for example, finance, music, shopping, email, instant messaging, searching, etc.

In accordance with the invention, as a network user browses the Internet, they can save the currently displayed webpage and optionally one or more the elements that make up the webpage to a network document manager service. This can be done in a plurality of ways. For example, the network user can select a button 446 from the links toolbar 450 or, if a network user has a downloadable toolbar 440 installed, as illustrated in FIG. 4, the network user can select a button 445 located on the downloadable toolbar 440. In alternate embodiments of the invention, a browser 400 can comprise one of the buttons 446, 445 according to a network user preference.

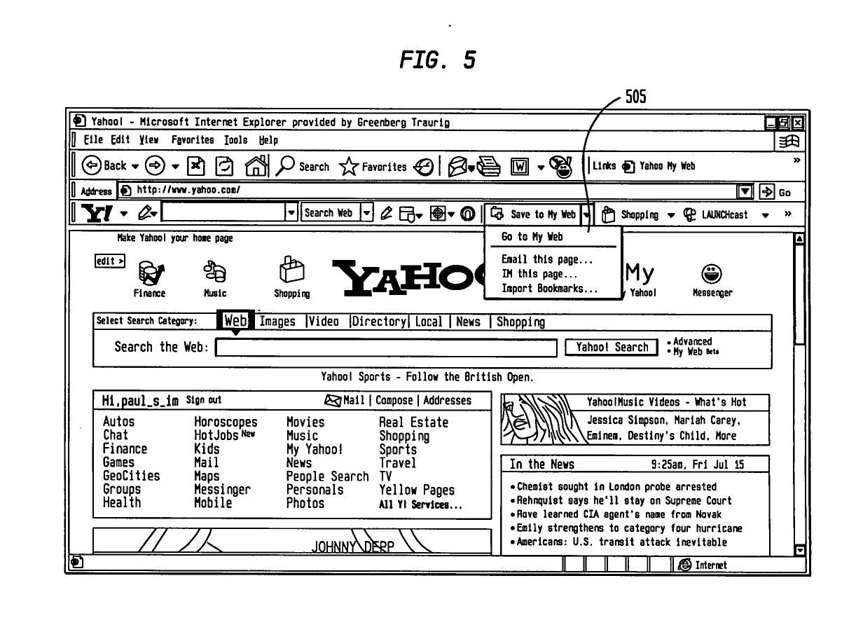

In addition to saving network documents, additional services can be offered through button 445 of downloadable toolbar 440. FIG. 5 illustrates a drop menu 505 for button 445, which a network user can access by selecting the downward facing arrow on button 445. The options on drop menu 505 include “Go to My Web”, “Email this Page”, “IM this Page” and “Import Bookmarks”. Selecting “Go to My Web” sends the Internet user to their network document manager, which is described with respect to FIGS. 9-11. The drop down menu 505 also provides options that allows a network user to email and/or IM the currently displayed page to another network user.

By selecting the “Import Bookmarks” item of menu 505, an Internet user can quickly import their bookmarks into their network document manager. Then they can use their network document manager to search their bookmarks and save copies of webpages. If the user's bookmarks are organized in folders, a similar folder structure can be made in the network document manager when the bookmarks are imported. In alternate embodiments of the invention, bookmarks can be stored locally or with a network content provider 126.

A network content provider can add additional network document management services by updating the contents of the toolbar button. One additional option can be an update feature, which updates the copies of the saved documents with the current version of the document available over the Internet, or an option can be presented to save the current version as a separate version to permit the user to track or compare changes to documents over time. In addition, instead of or in addition to providing these items in a toolbar button menu, network document management options can also be presented in a context menu, in a floating toolbar, in a separate browser window, in an explorer bar, a frame, etc.

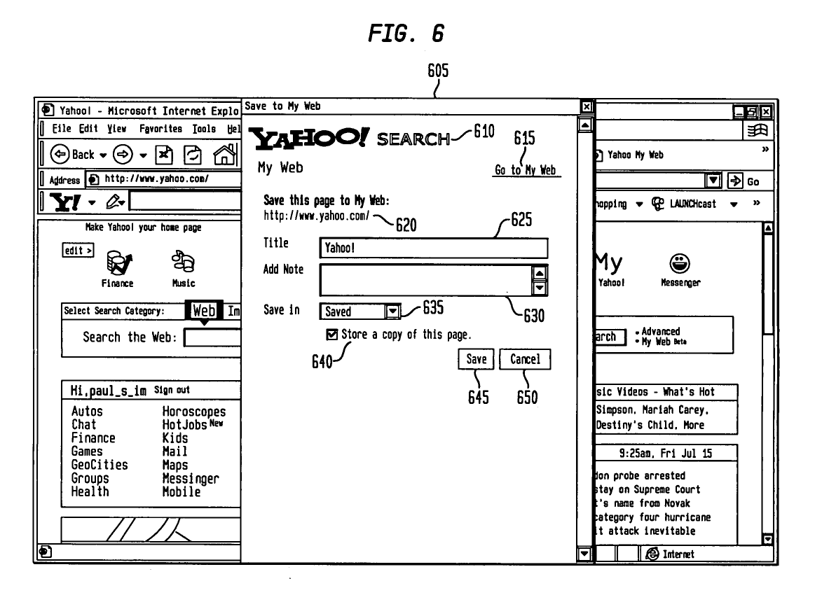

In some embodiments, when a network user selects either button 445 or button 446, a copy of the currently viewed document is automatically saved to a network content provider. In other embodiments, the saved content can exclusively or additionally be stored locally to permit the user to browse content without the need to be connected to the network, and document management functions can be provided through software stored locally at the user's computer that is similar in functionality to the software provided by the network content provider. In other embodiments of the invention, a save interface 605 is presented to the user to give the user more options when saving their documents. An exemplary save interface 605 is illustrated in FIG. 6. Saved interface 605 comprises a title area 610, a link to a network document manager 615, the URL 620 of the page that will be saved, a title field 625 that the network user can use to label their saved document, a note field 630 where the user can input notes regarding the saved document, a drop down menu 635 comprising a list of folders to which a network user can save the document, a check box 640 providing the network user the option of saving a copy of a document or saving a link to the document, a save button 645 and a cancel button 650, which the user can use to complete or cancel the operation. As mentioned earlier, in alternate embodiments of the invention, default settings can be used to automatically save the currently viewed document when buttons 445 or 446 are pressed.

Internet searching is a popular service provided by many Internet companies. But when a network user uses a search engine they can lose track of the websites that they visited. Therefore, in an embodiment of the invention, a network content provider can use a network or locally deployed document manager to save a search history of a network user.

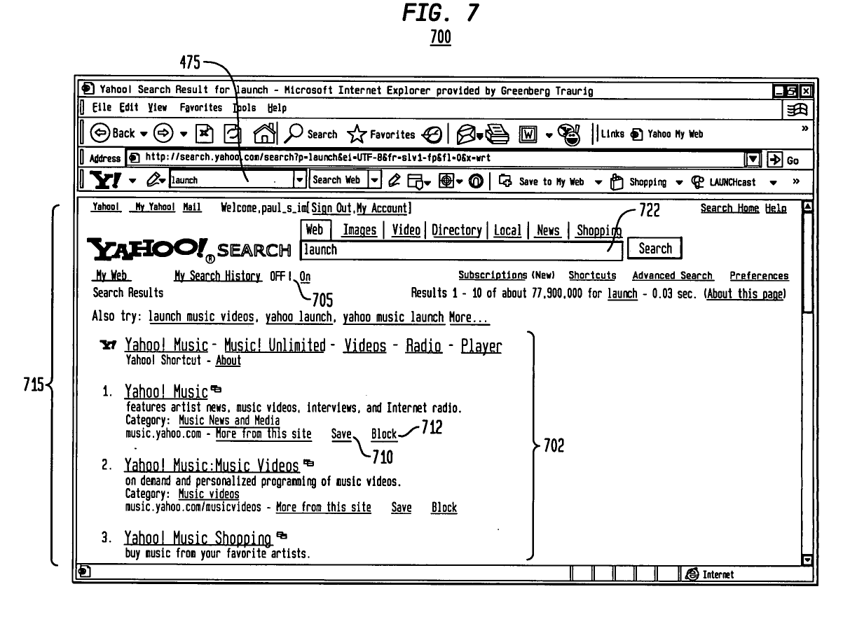

FIG. 7 illustrates an exemplary list of search results retrieved by a user from an Internet search company. A search could have been initiated from a Internet search page or from the search window 475 of the downloadable toolbar 440. The display section 715 of browser 700, comprises a field 722 for initiating another search, an option 705 for saving a search history and a list of search results 702. For example, searching the term “launch”, provides the hits listed in FIG. 7.

As mentioned above a network content provider can save the search history of a network user. Therefore, if a user selects one of the search results, the network content provider can save the accessed site and save the search term that the network user used to find the accessed site. At a later time, using a network document manager, a network user can view and manage, their search history. In alternate embodiments of the invention, a network content provider can save the history of a network user's entire session, regardless of whether a site was accessed from a search results list. The network content provider can save at least one element, such as, for example, the URL, of each electronic document accessed in a session by the user. In other embodiments, the entire electronic document can be saved. The user's session can be tracked, for example, by a downloadable network toolbar installed in the browser.

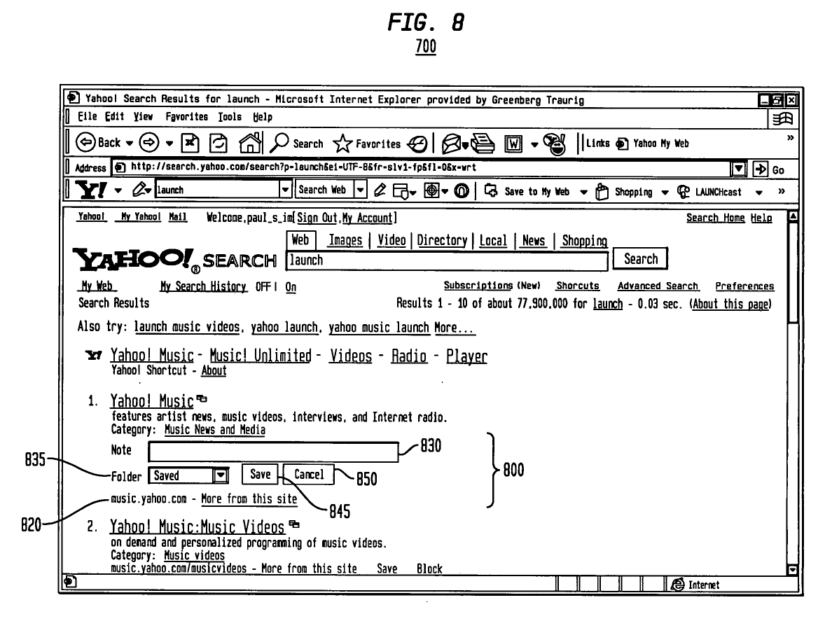

Each of the search results in list 702 also include a hyperlink 710 that a network user can use to quickly and conveniently save documents from the search results list 702. FIG. 8 illustrates an exemplary interface 800, which can be embedded in the search result list 702, that a network user sees when they select the “save” hyperlink 710. Save interface 800 comprises a note field 830, a folder selection menu 835, the URL 820 of the document, a save button 845 and a cancel button 850. The users options are similar to the save interface 605 of FIG. 6.

Returning to FIG. 7, each search result also comprises a “Block” hyperlink 712. If a user does not like the website listed in the search result, for example, because it is offensive, they can block the site, and it will no longer show up in future searches. Blocked sites can be managed from the network document manager or locally.

An network document management service also allows a network user to manage their documents through a network document manager. FIG. 9 illustrates an exemplary web based interface for a personal network manager 900. The personal network manager comprises a search field 905, a folder section 920 and a contents section 925.

A network user can use the network document manager to search their documents using terms related to the documents they are searching for. The terms can be entered into search field 905, and the search is initiated by selecting a button 910. In addition, a network user can use field 905 to search the web by selecting button 915.

Folder section 920 comprises a Saved folder, a History folder, a Blocked folder and a Shared folder. Additional folders can be add to the list by a network user. In addition, if a network user imported their bookmarks, the folder structure used for the bookmarks is copied in the folder section 920. The saved folder comprises a list of all saved documents, the history folder, shows the user their search history, the blocked folder comprises a list of blocked sites, and the shared folder comprises a list of documents that the network user wishes to share with other network users.

Contents of a selected folder are displayed in content section 925. Each of the listed documents comprises a selection box similar to box 930. Network users select the boxes next to the documents they want to manipulate. Selecting box 930 selects all the documents. A network user can go back to a document as is currently available over the network by selecting the title 902 of the document, or if a user saved a copy of the document, they can access that copy by selecting the “My Saved Copy” hyperlink 960.

The content section 925 comprises a plurality of buttons and interfaces that a network user can use to manipulate their documents. For example, button 935 allows the network user to email selected documents to other users. Button 940 allows the network user to instant message documents to other users and button 945 allows users to delete documents. Drop down menu 950 allows the network user to move documents to different folders and drop down menu 955 allows a network user to sort their documents by different parameters. Exemplary parameters include sorting by date, by title, by URL, and by the search the document was found by. An additional option can include updating the saved content associated with a document.

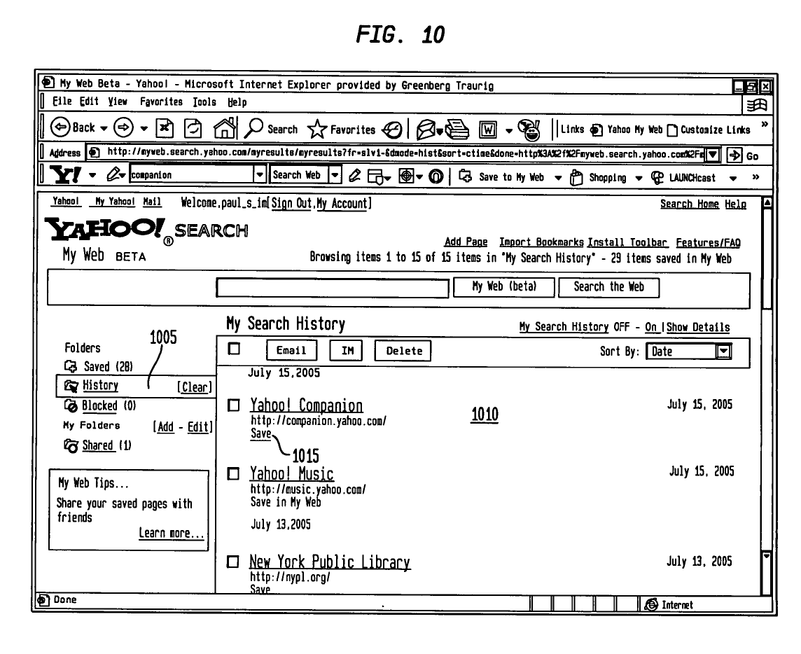

FIG. 10 illustrates an exemplary search history 1010 of a network user, accessed from History folder 1005. A network content provider can save the history of the websites visited by a network user and the search term used to find the visited website. This is particularly helpful to a network user who performs Internet research, but cannot remember where they visited. The search history 1010, in FIG. 10 is sorted by date, but can also be sorted by other factors. Documents listed on the search history 1010 can be saved to the network document manager by selecting the “Save” hyperlink 1015.

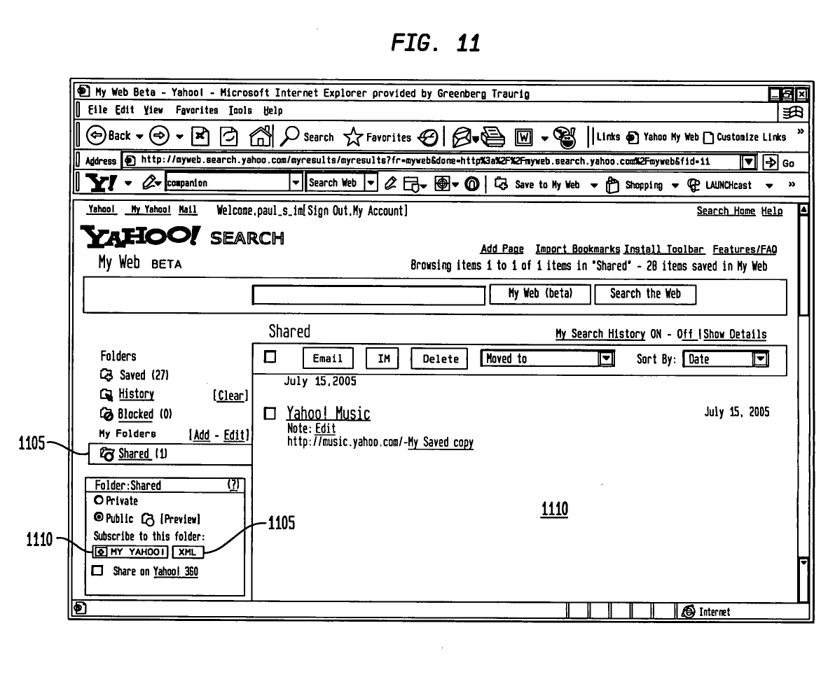

Using the exemplary network document manager, a network user can share their saved documents with other network users. FIG. 11 illustrates the contents of an exemplary shared folder 1105. Document list section 1110 lists the documents shared by the network user. The network user can share their documents in a plurality of ways. For example, they can publish their shared documents using RSS, and other network users can subscribe to the shared folder to view its contents. The XML required for the feed can by accessed by pressing button 1105.

In addition, some network content providers give network users access to a personal webpage designed by the network user. This personal page is a convenient starting point for network users. A network user can post their shared documents on this personal web page by pressing button 1110.

It will be recognized that while the features and functions described above are described in relation to network components and user side components, such features and functions can be implemented at any point in the network, on single or multiple computers and/or servers, and network functions can also be duplicated at the user computer for functioning independent of the network if desired. Thus user side changes and or network side changes can be resolved and or synchronized when a user returns to the network in manners known in the art or hereafter to become known.

While the description of the various embodiments of the invention are described in a server/client network environment, alternate embodiments of the invention can be performed in a peer-to-peer network or other interconnectivity schemes now known or hereafter to become known.

While there have been shown and described and pointed out fundamental novel features of the invention as applied to preferred embodiments thereof, it will be understood that various omissions and substitutions and changes in the form and detail of the disclosed invention may be made by those skilled in the art without departing from the spirit of the invention. It is the intention, therefore, to be limited only as indicated by the scope of the claims appended hereto.

What is claimed:

1. A method of electronic document storage comprising:
receiving a request to save at least one element of at least one electronic document; and
saving said at least one element of at least one electronic document on a network content provider computer, wherein said at least one element of at least one electronic document is retrieved from a local computer.

2. The method of claim 1, wherein said at least one element of at least one document is retrieved from a document object model.

3. The method of claim 1, wherein said request comprises said at least one element of at least one electronic document.

4. The method of claim 1, wherein said at least one element of at least one electronic document is an HTML document.

5. The method of claim 1, wherein said at least one element of at least one electronic document is an electronic image.

6. The method of claim 1, wherein said at least one element of at least one electronic document is a portable document file.

7. The method of claim 1, wherein said at least one element of at least one electronic document is a universal resource identifier for said electronic document.

8. The method of claim 1 further comprising, logging a user in with a network content provider.

9. The method of claim 1, wherein said at least one element of at least one electronic document is stored in a searchable form.

10. The method of claim 1 further comprising, saving said at least one element of at least one electronic document from a search result.

11. The method of claim 1, wherein said at least one element is not available from a local computer, the method further comprising accessing a document outline and retrieving the at least one element via the document outline.

12. The method of claim 11, wherein the document outline is a document object model.

13. The method of claim 1, wherein said save request is initiated from an extension to a browser.

14. The method of claim 13, wherein said save request is initiated from a toolbar.

15. The method of claim 14 further comprising, providing a downloadable toolbar operable with a browser application for viewing electronic documents.

16. The method of claim 1 further comprising, labeling said at least one element of at least one electronic document as a public document.

17. The method of claim 16 further comprising, publishing said public document on a webpage dedicated to a network service user.

18. The method of claim 1 further comprising, transmitting said public document to a network user.

19. The method of claim 1 further comprising, updating said at least one element of at least one electronic document with a current element available over a network.

20. The method of claim 1 further comprising, saving at least one element of every electronic document accessed by a network user during a session.

21. An graphical user interface comprising:
a user selectable component, wherein selection of said component initiates a storage operation comprising:
initiating a request to save at least one element of at least one electronic document; and
transmitting said at least one element of at least one electronic document to a network content provider computer, wherein said at least one element is retrieved from a local computer.

22. The graphical user interface of claim 21, wherein said at least one element is not available from a local computer, the operation further comprising accessing a document outline and retrieving the at least one element via the document outline.

23. The graphical user interface of claim 21, wherein said user selectable component is a button.

24. The graphical user interface of claim 21, wherein said user selectable component is a hyperlink.

25. The graphical user interface of claim 21, wherein said request comprises said at least one element of at least one electronic document.

26. The graphical user interface of claim 21, wherein said at least one element of at least one electronic document is an HTML document.

27. The graphical user interface of claim 21, wherein said at least one element of at least one electronic document is an electronic image.

28. The graphical user interface of claim 21, wherein said at least one element of at least one electronic document is a portable document file.

29. The graphical user interface of claim 21, wherein said at least one element of at least one electronic document is a universal resource identifier for said electronic document.

30. The graphical user interface of claim 21, wherein said user selectable component can be accessed from a search result.

31. The graphical user interface of claim 21, wherein said user selectable component is displayed in a context menu.

32. The graphical user interface of claim 21, wherein said user selectable component is displayed on a toolbar.

33. The graphical user interface of claim 32, wherein said toolbar is a downloadable toolbar, operable with a browser application for viewing electronic documents.

34. The graphical user interface of claim 32 further comprising, user selectable components for transmitting said at least one element of at least one electronic document to a network user.

35. A graphical user interface comprising:
a search field;
a first display region for listing one or more folders; and
a second display region for listing the contents of a selected folder, wherein said folders comprises a link to at least one element of at least one electronic document saved on a network content provider computer, wherein said at least one element of at least one electronic document was saved from a network user computer.

36. The graphical user interface of claim 35, wherein said first display region comprises a shared folder, wherein contents of said shared folder are available to other network users.

37. The graphical user interface of claim 35 further comprising, user selectable components for transmitting said at least one element of at least one electronic document to a network user.

38. The graphical user interface of claim 35 further comprising, user selectable components for publishing said at least one element of at least one electronic document on a webpage dedicated to a network service user.

39. The graphical user interface of claim 35 further comprising, a folder comprising at least one element of every electronic document accessed by a network user during a session.

40. A computer readable storage medium, wherein said medium stores instructions for a computer, said instructions defining at least one routine for:
receiving a request to save at least one element of at least one electronic document; and
saving said at least one element of at least one electronic document on a network content provider computer, wherein said at least one element of at least one electronic document is retrieved from a local computer.

41. The computer readable storage medium of claim 40, wherein said request comprises said at least one element of at least one electronic document.

42. The computer readable storage medium of claim 40, wherein said at least one element of at least one electronic document is an HTML document.

43. The computer readable storage medium of claim 40, wherein said at least one element of at least one electronic document is an electronic image.

44. The computer readable storage medium of claim 40, wherein said at least one element of at least one electronic document is a portable document file.

45. The computer readable storage medium of claim 40, wherein said at least one element of at least one electronic document is a universal resource identifier for said electronic document.

46. The computer readable storage medium of claim 40, wherein said routine further comprises logging a user in with a network content provider.

47. The computer readable storage medium of claim 40, wherein said at least one element of at least one document is retrieved from a document object model.

48. The computer readable storage medium of claim 40, wherein said at least one element of at least one electronic document is stored in a searchable form.

49. The computer readable storage medium of claim 40, wherein said routine further comprises saving said at least one element of at least one electronic document from a search result.

50. The computer readable storage medium of claim 40, wherein said medium further stores instructions for executing a toolbar.

51. The computer readable storage medium of claim 50, wherein said toolbar is a downloadable toolbar operable with a browser application for viewing electronic documents.

52. The computer readable storage medium of claim 40, wherein said routine further comprises labeling said at least one element of at least one electronic document as a public document.

53. The computer readable storage medium of claim 52, wherein said routine further comprises publishing said public document on a webpage dedicated to a network service user.

54. The computer readable storage medium of claim 40, wherein said routine further comprises transmitting said public document to a network user.

55. The computer readable storage medium of claim 40, wherein said routine further comprises updating said at least one element of at least one electronic document with a current element available over a network.

56. The computer readable storage medium of claim 40, wherein said routine further comprises saving at least one element of every electronic document accessed by a network user during a session.

57. A server on a computer network, comprising a computer readable storage medium, wherein said medium stores instructions for a computer, said instructions defining at least one routine for:
receiving a request to save at least one element of at least one electronic document; and
saving said at least one element of at least one electronic document on a network content provider computer, wherein said at least one element of at least one electronic document is retrieved from a local computer.

58. The server of claim 57, wherein said at least one element of at least one document is retrieved from a document object model.

59. The server of claim 57, wherein said request comprises said at least one element of at least one electronic document.

60. The server of claim 57, wherein said at least one element of at least one electronic document is an HTML document.

61. The server of claim 57, wherein said at least one element of at least one electronic document is an electronic image.

62. The server of claim 57, wherein said at least one element of at least one electronic document is a portable document file.

63. The server of claim 57, wherein said at least one element of at least one electronic document is a universal resource identifier for said electronic document.

64. The server of claim 57, wherein said routine further comprises logging a user in with a network content provider.

65. The server of claim 57, wherein said at least one element of at least one electronic document is stored in a searchable form.

66. The server of claim 57, wherein said routine further comprises saving said at least one element of at least one electronic document from a search result.

67. The server of claim 57, wherein said server provides a downloadable toolbar operable with a browser application for viewing electronic documents.

68. The server of claim 57, wherein said routine further comprises labeling said at least one element of at least one electronic document as a public document.

69. The server of claim 68, wherein said routine further comprises publishing said public document on a webpage dedicated to a network service user.

70. The server of claim 57, wherein said routine further comprises transmitting said public document to a network user.

71. The server of claim 57, wherein said routine further comprises updating said at least one element of at least one electronic document with a current element available over a network.

72. The server of claim 57, wherein said routine further comprises saving at least one element of every electronic document accessed by a network user during a session.
